(19) United States
(12) Patent Application Publication
(10) Pub. No.: US 2025/0061398 A1
(43) Pub. Date: Feb. 20, 2025

(54) SYSTEMS AND METHODS TO EFFECTUATE SETS OF AUTOMATED ACTIONS WITHIN A COLLABORATION ENVIRONMENT BASED ON TRIGGER EVENTS

(71) Applicant: Asana, Inc., San Francisco, CA (US)

(72) Inventors: Eric Seth Pelz, San Francisco, CA (US); Micah Hanan Fenner, San Francisco, CA (US); Abigail Lorean Kelly, San Francisco, CA (US); Cvetomir I. Cankov, Oakland, CA (US); Alexander Thomas Ryan, San Francisco, CA (US); Adrian Van Yen, Saratoga, CA (US); John Wesley Graham, San Francisco, CA (US); Anna Marie Clifton, San Francisco, CA (US); Lili Jiang Rachowin, San Francisco, CA (US); Sika Gasinu, Berkeley, CA (US)

(21) Appl. No.: 17/967,747

(22) Filed: Oct. 17, 2022

Related U.S. Application Data
(63) Continuation of application No. 16/787,451, filed on Feb. 11, 2020, now abandoned.

(51) Int. Cl. G06Q 10/0631; G06N 5/04

(52) U.S. Cl. CPC G06Q 10/06316; G06N 5/04; G06Q 10/06313

(57) ABSTRACT

Systems and methods for effectuating sets of automated actions within a collaboration environment based on trigger events are disclosed. Exemplary implementations may: manage environment state information maintaining a collaboration environment, the collaboration environment being configured to facilitate interaction by users with the collaboration environment, the environment state information including values of environment parameters; generate automation information based on user entry and/or selection of the automation information into a user interface, the automation information specifying sets of automated actions to carry out in the collaboration environment in response to occurrence of trigger events; detect occurrence of the trigger events based on changes in the values of the environment parameters; responsive to the detection of the occurrence of individual trigger events, effectuate individual sets of automated actions within the collaboration environment; and/or perform other operations.

### FIELD OF THE DISCLOSURE

The present disclosure relates to systems and methods to effectuate sets of automated actions within a collaboration environment based on trigger events.

### BACKGROUND

Collaboration environments, sometimes referred to as integrated collaboration environments, may enable users to assign projects, tasks, or other assignments to assignees (e.g., other users) to complete. A collaboration environment may comprise an environment in which a virtual team of users does its work. A collaboration environment may enable users to work in a more organized and efficient manner. A collaboration environment may integrate features and/or functionality such as web-based conferencing and collaboration, desktop videoconferencing, and/or instant message into a single easy-to-use, intuitive interface.

### SUMMARY

One aspect of the present disclosure relates to a system configured to effectuate sets of automated actions within a collaboration environment based on trigger events. Collaboration environments may require users to manually interact with the collaboration environment in response to actions of other users and/or other events occurring within the collaboration environment. The responsive interactions may include, for example, creating and/or assigning tasks within the collaboration environment. Over time, the users may tend to follow patterns with how they react to certain events and/or actions within the collaboration environment. This may create a negative experience for users who may tire of the potentially repetitive work. Requiring such repetitive manual interaction may increase friction within the collaboration environment. One or more implementations of the systems and methods presented herein may create less friction and/or more efficient use of the collaboration environment by users by effectuating automatic sequences of actions in response to trigger events. The automated actions and/or trigger events may be user specified.

One or more implementations of a system configured to effectuate sets of automated actions within a collaboration environment based on trigger events may include one or more hardware processors configured by machine-readable instructions. The processor(s) may be configured to manage environment state information maintaining a collaboration environment. The collaboration environment may be configured to facilitate interaction by users with the collaboration environment. The environment state information may specify values of environment parameters and/or other information. The environment parameters may include one or more of user parameters, work unit parameters, and/or other parameters. The values of the user parameters may describe one or more of the users, user actions of the users within the collaboration environment, user settings of the users, and/or other information about the users. The values of work unit parameters may describe units of work managed, created, and/or assigned within the collaboration environment, and/or other information about units of work.

The processor(s) may be configured to generate automation information and/or other information. The automation information may be generated based on user entry and/or selection of the automation information into a user interface. The automation information may specify sets of automated actions to carry out in the collaboration environment in response to occurrence of trigger events. The user entry and/or selection of the automation information may include entry and/or selection of one or more of individual automated actions in individual sets of automated actions, individual trigger events, and/or other information. By way of non-limiting illustration, the automation information may specify a first set of automated actions to carry out in response to a first trigger event. The first set of automated actions and/or the first trigger event may be generated based on input by a first user into a user interface.

The processor(s) may be configured to detect occurrence of the trigger events. The occurrence of the trigger events may be based on changes in the values of the environment parameters and/or other events occurring within the collaboration environment. By way of non-limiting illustration, an occurrence of the first trigger event may be detected based on a first change in a first value of a first environment parameter to a second value. In some implementations, the first trigger event may be associated with the first change (e.g., a state change of the first environment parameter). In some implementations, the first trigger event may be associated with the second value (e.g., a data change of the first environment parameter).

The processor(s) may be configured to effectuate individual sets of automated actions within the collaboration environment. The effectuation of the individual sets of automated actions may be responsive to the detection of the occurrence of individual trigger events. By way of non-limiting illustration, responsive to the detection of the first trigger event, the first set of automated actions may be effectuated within the collaboration environment.

As used herein, any association (or relation, or reflection, or indication, or correspondence) involving servers, processors, client computing platforms, and/or another entity or object that interacts with any part of the system and/or plays a part in the operation of the system, may be a one-to-one association, a one-to-many association, a many-to-one association, and/or a many-to-many association or N-to-M association (note that N and M may be different numbers greater than 1).

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to effectuate sets of automated actions within a collaboration environment based on trigger events, in accordance with one or more implementations.

FIG. 2 illustrates a method to effectuate sets of automated actions within a collaboration environment based on trigger events, in accordance with one or more implementations.

FIG. 3 illustrates an exemplary user interface, in accordance with one or more implementations.

FIG. 4 illustrates an exemplary user interface, in accordance with one or more implementations.

### DETAILED DESCRIPTION

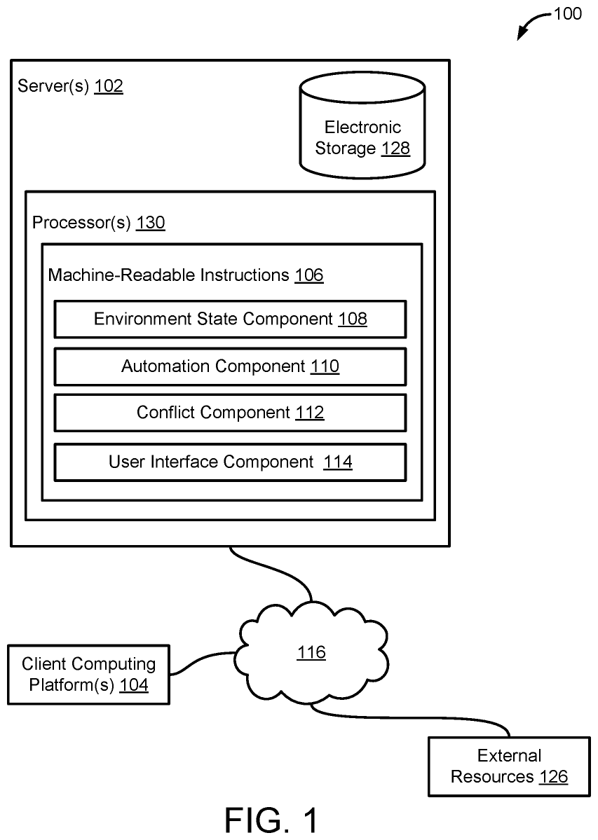

FIG. 1 illustrates a system 100 configured to effectuate sets of automated actions within a collaboration environment based on trigger events, in accordance with one or more implementations. One or more implementations of the systems and methods presented herein may create less friction and/or more efficient use of the collaboration environment by users by effectuating automatic sequences of actions in response to trigger events. The actions and/or triggers may be user specified.

In some implementations, system 100 may include one or more of one or more servers 102, one or more client computing platforms 104, external resources 126, and/or other components. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may include one or more of non-transitory electronic storage 128, one or more processors 130 configured by machine-readable instructions 106, and/or other components. Machine-readable instructions 106 may include one or more instruction components. The instruction components may include computer program components. Executing the machine-readable instructions 106 may cause server(s) 102 to facilitate effectuating sets of automated actions within a collaboration environment based on trigger events. The instruction components may include one or more of an environment state component 108, an automation component 110, a conflict component 112, a user interface component 114, and/or other instruction components.

Environment state component 108 may be configured to manage environment state information and/or other information used in maintaining a collaboration environment. The environment state information may include values of one or more environment parameters. The environment parameters may include one or more of user parameters, work unit parameters, and/or other parameters. The values of the user parameters may specify user information and/or other information. The values of the work unit parameters may specify work information and/or other information.

The values of the user parameters may be organized in user records corresponding to users interacting with and/or viewing the collaboration environment. The values of the user parameters associated with the users interacting with and/or viewing the collaboration environment may include information describing the users, user actions of the users within the collaboration environment, their settings, and/or other user information; and/or metadata associated with the users, their actions within the environment, their settings, and/or other user information. Individual ones of the users may be associated with individual ones of the user records. A user record may define values of the user parameters associated with a given user interacting with and/or viewing the collaboration environment.

The values of the user parameters may, by way of non-limiting example, specify one or more of: a user name, a group parameter, a user account, a user role, a user department, descriptive user content, a to-email, a from-email, a photo, an organization, a workspace, one or more projects (which may include project parameters defined by one or more work unit records), one or more portfolios of projects, one or more items of work (which may include one or more unit of work parameters defined by one or more unit of work records), one or more user comments, one or more teams the user belongs to, one or more of the user display settings (e.g., colors, size, project order, task order, other unit of work order, etc.), one or more authorized applications, one or more interaction parameters (e.g., indicating a user is working on/worked on a given unit of work, a given user viewed a given work unit of work, a given user selected a given unit of work, a timeframe a given user last interacted with and/or worked on a given unit of work, a time period that a given unit of work has been idle, and/or other interaction parameters), a presence parameter (e.g., indicating presence and/or interaction level at an environment level, unit of work level, project level, task level, application level, etc.), one or more notification settings, one or more progress parameters, status information for one or more work units the user is associated with (units of work assigned to the user, assigned to other users by the user, completed by the user, past-due date, and/or other information), application access information (e.g., username/password for one or more third-party applications), one or more favorites and/or priorities, one or more values of one or more workload parameters (e.g., one or more measures of current and future workload associated with units of work assigned to a user), and/or other information for the given user.

The values of the work unit parameters may be organized in work unit records corresponding to units of work managed, created, and/or assigned within the collaboration environment. A given work unit may have one or more assignees and/or team members working on the given work unit. Work units may include one or more to-do items, action items, objectives, and/or other units of work one or more users should accomplish and/or plan on accomplishing. Units of work may be created by a given user for the given user and/or created by the given user and assigned to one or more other users. A given unit of work may include one or more projects, tasks, sub-tasks, and/or other units of work assigned to and/or associated with one or more users.

By way of non-limiting illustration, the one or more work unit parameters may include one or more of a work assignment parameter, a work management parameter, work creation parameter, and/or other parameters. The values of the work assignment parameter may describe units of work assigned to the individual users. The values of the work management parameter may describe units of work managed by the individual users. The values of the work creation parameter may describe units of work created by the individual users.

In some implementations, the units of work may be described based on one or more of a unit of work name, a unit of work description, one or more unit of work dates (e.g., a start date, a due date, a completion date, and/or dates), one or more members associated with a unit of work (e.g., an owner, one or more other project/task members, member access information, and/or other unit of work members and/or member information), a status parameter (e.g., an update, a hardcoded status update, a completed/uncomplete/mark complete, a measured status, a progress indication, quantity of sub-work units remaining for a given unit of work, completed work units in a given project, and/or other status parameter), one or more user comment parameters (e.g., permission for who may comments such as a creator, a recipient, one or more followers, and/or one or more other interested parties; content of the comments; one or more times; presence or absence of the functionality of up-votes; one or more hard-coded responses; and/or other parameters.), one or more interaction parameters (e.g., indicating a given unit of work is being worked on/was worked on, given work unit of work was viewed, a given unit of work was selected, how long the given unit of work has been idle, a last interaction parameter indicating when and what user last interacted with the given unit of work, users that interacted with the given unit of work, and/or other interaction parameters indicating sources of the interactions, context of the interactions, content of the interactions and/or time for the interactions), one or more file attachments, notification settings, privacy, an associated URL, one or more interaction parameters (e.g., sources of the interactions, context of the interactions, content of the interactions, time for the interactions, and/or other interaction parameters), updates, ordering of units of work within a given unit of work (e.g., tasks within a project, subtasks within a task, etc.,), state of a workspace for a given unit of work (e.g., application state parameters, application status, application interactions, user information, and/or other parameters related to the state of the workspace for a unit of work), dependencies between one or more work units, one or more custom fields (e.g., priority, cost, stage, and/or other custom fields), and/or other values of work unit parameters.

The values of the work assignment parameter describing units of work assigned to the individual users may be determined based on one or more interactions by one or more users with a collaboration environment. In some implementations, one or more users may create and/or assign one or more unit of work to themselves and/or an other user. In some implementations, a user may be assigned a unit of work and the user may effectuate a reassignment of the unit of work from the user or one or more other users.

In some implementations, values of the work assignment parameter may indicate that a status parameter of a unit of work has changed from “incomplete” to “marked complete” and/or “complete”. In some implementations, a status of complete for a unit of work may be associated with the passing of an end date associated with the unit of work. In some implementations, a status of “marked complete” may be associated with a user providing input via the collaboration environment at the point in time the user completes the unit of work (which may be before or after an end date).

In some implementations, user actions within the collaboration environment may include effectuating one or more changes in one or more values of one or more of the environment parameters. User actions may be facilitated through a user interface presenting the collaboration environment. By way of non-limiting illustration, a user action may include marking a unit of work “complete.” Marking a unit of work complete may change a value of a work unit parameter for the unit of work from “incomplete” to “marked complete.” User actions may include other changes to other values of other environment parameters described herein.

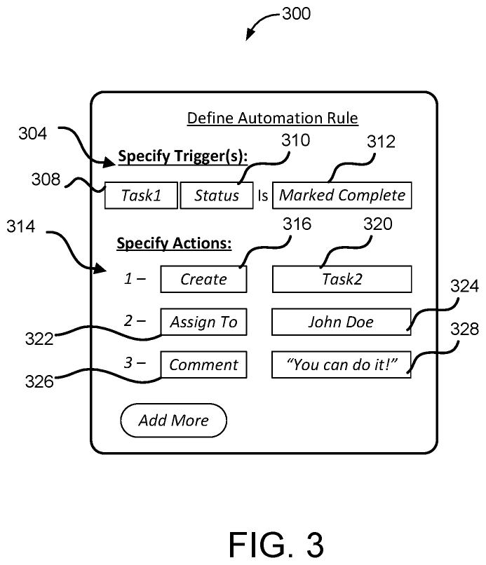

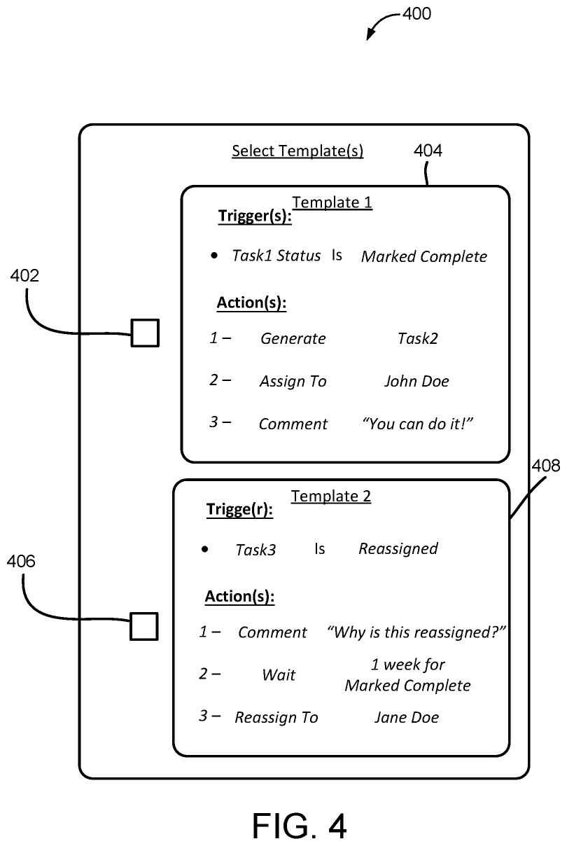

The automation component 110 may be configured to generate automation information and/or other information. The automation information may be generated based on user entry and/or selection of the automation information into a user interface (see, e.g., user interface component 114, FIG. 3, and/or FIG. 4). The automation information may specify sets of automated actions to carry out in the collaboration environment in response to occurrence of trigger events. The user entry and/or selection of the automation information may include entry and/or selection of one or more of individual automated actions in individual sets of automated actions, individual trigger events, and/or other information. By way of non-limiting illustration, the automation information may specify a first set of automated actions to carry out in response to a first trigger event. The first set of automated actions and/or the first trigger event may be generated based on input by a first user into a user interface.

The automation component 110 may be configured to detect occurrence of the trigger events based on changes in the values of the environment parameters and/or other information. Detection may be based on monitoring environment state information, user actions, and/or other components of system 100. By way of non-limiting illustration, an occurrence of the first trigger event may be detected based on a first change in a first value of a first environment parameter to a second value.

In some implementations, an individual automated action may include effectuating one or more of creation of, change in, and/or specification of, one or more values of one or more of the environment parameters. In some implementations, the creation of, change in, and/or specification of values of environment parameters may be accomplished by accessing a corresponding record (e.g., user record, work unit record, and/or other records). In some implementations, creation of, change in, and/or specification of an individual value may be reflected in views of the collaboration environment accessed by users.

In some implementations, individual automated actions may be classified by with individual action types. An action type may dictate the extent in which an automation action effects the collaboration environment. An action type may include one or more of a record creation type, value specification type, and/or other types. A record creation type automated action may include creating one or more of a user record, work unit record, and/or other records. The creation of a record may include generating an instance of the record in the collaboration environment. The creation of the record by a record creation type automated action may not specifically define values of the environment parameters within the record and/or may set values to one or more of default values, null values, and/or other values. A value specification type automated action may include changing, and/or specifying, one or more values of one or more of the environment parameters contained within a record.

In some implementations, value specification type automated action may further be classified by one or more action subtypes based on the individual values of the individual environment parameters associated with the individual automated actions. An action subtype may include one or more of a time-based subtype, privacy and/or permissions subtype, accessibility subtype, interaction subtype, and/or other subtype.

An automated action of the time-based subtype may effectuate change in, and/or specification of, one or more values of one or more of the environment parameters related to time. For a work unit record, this may include one or more unit of work dates (e.g., a start date, a due date, a completion date, and/or dates). For a user record, this may include one or more of a start of employment date, an end of employment date, a length of employment period, a length of vacation period, and/or other information.

An automated action of the privacy and/or permissions subtype may correspond to values of environment parameters related to privacy and/or permissions. By way of non-limiting illustration, an automated action performed on a user record being of the privacy and/or permissions subtype may include change of, and/or specification of, one or more of one or more teams a user belongs to, one or more user display settings (e.g., colors, size, project order, task order, other unit of work order, etc.), one or more authorized applications, application access information (e.g., username/password for one or more third-party applications), one or more favorites and/or priorities, and/or other information for the user. By way of non-limiting illustration, an automated action performed on a work unit record being of the privacy and/or permissions subtype may include change of, and/or specification of, one or more of one or more user comment parameters (e.g., permission for who may comments such as a creator, a recipient, one or more followers, and/or one or more other interested parties; content of the comments; one or more times; presence or absence of the functionality of up-votes; one or more hard-coded responses; and/or other parameters.), notification settings, privacy settings, dependencies between one or more work units, and/or other values.

An automated action of the accessibility subtype may correspond to values of environment parameters which may be required in a record (user and/or work unit) in order for the record to take effect within the collaboration environment. Values of environment parameters which may be required in a record in order for the record to take effect may refer to values that, if left undefined, would not provide any meaningful use within the collaboration environment. In other words, the values of environment parameters which may be required in a record in order for the record to take effect may refer to a minimum quantity of environment parameters which may need to be specified in order to allow users to interact with and/or access the record. By way of non-limiting illustration, an automated action performed on a user record being of the accessibility subtype may include change of, and/or specification of, one or more of a user name, a user account, a user role, a user department, descriptive user content, a to-email, a from-email, a photo, an organization, and/or other values. By way of non-limiting illustration, an automated action performed on a work unit record being of the accessibility subtype may include change of, and/or specification of, one or more of a unit of work description, one or more members associated with a unit of work (e.g., an owner, one or more other project/task members, member access information, one or more assignees, and/or other information), an associated URL, and/or other values.

An automated action of the interaction subtype may correspond to values of environment parameters which may be specified in a record (user and/or work unit) in order to provide further functionality and/or accessibility within the collaboration environment. Values of environment parameters which may be specified in a record (user and/or work unit) in order to provide further functionality and/or accessibility may refer to values other than those associated with the time-based subtype, privacy and/or permissions subtype, accessibility subtype, and/or other subtypes.

It is noted that the classification of automated actions into action types and/or subtypes, and/or the descriptions of the different actions types and/or subtypes are provided for illustrative purposes only. Instead, it is to be understood that action types and/or subtype may be described in other ways, and/or automated actions may be classified in other ways.

In some implementations, an individual automated action may be carried out simultaneously (or near simultaneously) with an individual detection of an individual occurrence of an individual trigger event and/or within a specified time frame following an individual detection of an individual occurrence of an individual trigger event. In some implementations, a specified time frame may include a “waiting” period of time before an action is carried out. In some implementations, the waiting period of time may be satisfied by one or more of the passage of the period of time, some other trigger event, and/or other events and/or actions within the collaboration environment.

In some implementations, individual trigger events may be specified as individual occurrences of change of the values of the environment parameters. Occurrences of change may convey a state change of an environment parameter. The state change may not consider what the change is, but instead that a change occurred. For example, a trigger event may include an occurrence of a reassignment of a unit of work from one user to an other user. By way of non-limiting illustration, the first trigger event may be associated with the first change.

In some implementations, individual trigger events may be specified as individual values of the environment parameters. Changes to specific values may be referred to as data state changes. The data state change may refer to a change of a parameter to a specific value from an other value (and/or from a state of being unspecified). For example, a trigger event may include an occurrence of a reassignment of a unit of work from one user to another specific user. For example, a trigger event may include a comment having one or more specific words and/or phrases. By way of non-limiting illustration, the first trigger event may be associated with the second value and/or other values.

In some implementations, a set of automated actions may be associated with one or more of a sequence in which automated actions in the set are to be carried out, concurrent carrying out of two or more of the automated actions in the set, and/or other features and/or functionality. The automated actions within a set of automated actions may have a specified ordered sequence in which the automated actions are to be carried out. In some implementations, one or more actions may be followed by, and/or preceded by, a specified waiting period. A set of automation actions may specify that two or more actions may be carried out concurrently. In some implementations, a user may specify a combination and/or sequence of multiple triggers and/or multiple automated actions as a multi-step “workflow” that may include branching logic. By way of non-limiting illustration, a chain of trigger/action pairs of a given sequence may result in facilitating a workflow.

In some implementations, individual sets of automated actions and associated individual trigger events may be stored in individual automation records. An automation record may define one or more of individual actions, individual trigger events, and/or other information. Individual actions may be defined by a target component, an action component, and/or other information. The target component of an automation record may include the environment parameter (or parameters) to which an action is to be carried out on. The action component of an automation record may define what change is to be made on the environment parameter (or parameters) defined by the target component.

Individual trigger events may be defined by a source component, an event component, and/or other information. The source component of an automation record may include the environment parameter (or parameters) from which occurrences of a trigger event may be derived. The event component may include the value (or change in the value) for the environment parameter (or parameters) defined by the source component from which occurrences of a trigger event may be derived.

In some implementations, individual automation records may store counts of occurrences of individual trigger events and/or occurrences of carrying out individual automation actions in the sets of automation actions.

It is noted that while some descriptions presented herein may be directed to an individual trigger event causing an individual set of automated actions to be carried out within the collaboration environment, this is for illustrative purposes only and not to be considered limiting. For example, in some implementations, multiple trigger events may be combined together through some logic criteria, that when satisfied, may cause an individual set of automated actions to be carried out within the collaboration environment. Logic may include, for example, Boolean logic. By way of non-limiting illustration, logic operators such as “AND”, “OR”, “NOT”, and/or other operations may be utilized to generate more complex trigger combinations for sets of automated actions. In some implementations, the use of logic operators may allow for fewer discrete trigger events to be defined yet still have more complex behavior available to users. For example, there may not need to specify a trigger event of “when task is unassigned”, since through the use of a logic operator “NOT”, a trigger event may be defined by “when task assigned” combined with the operator “NOT”. Further, the Boolean logic may facilitate multistage automation. By way of non-limiting illustration, instead of input “than-if-then” or “if-and-if-then”, logic may include “if-then-then” and/or other operators. In some implementations, a user may specify a set, or pool, of trigger events to trigger one or more automated actions. In some implementations, user may specify that one or more of the trigger events in the set may individually and/or in combination trigger the one or more automated actions. This way, a user may specify multiple options of trigger events which may trigger one or more automated actions. Further, an individual trigger event may trigger multiple automated actions.

The automation component 110 may be configured to, responsive to the detection of the occurrence of individual trigger events, effectuate individual sets of automated actions within the collaboration environment. By way of non-limiting illustration, responsive to the detection of the first trigger event, automation component 110 may be configured to effectuate the first set of automated actions within the collaboration environment.

The automation component 110 may be configured to determine individual sets of repeated user actions by the individual users. The determination may be based on monitoring environment state information (e.g., change in values of environment parameters and/or other monitoring), user actions, and/or other components of system 100. In some implementations, determining individual sets of repeated user actions by the individual users may include determining one or more actions and/or events occurring within the collaboration environment which precede the individual sets of repeated user actions. In some implementations, a set of user actions may be deemed “repeated” after the set of user actions occur more than once.

The automation component 110 may be configured to generate recommendations for automation information based on individual sets of repeated user actions and/or other information. The recommendations may include individual recommended sets of automated actions and/or individual recommended trigger events which correspond to the individual sets of repeated user actions. In some implementations, recommended trigger events may include the actions and/or events occurring within the collaboration environment which precede the individual sets of repeated user actions. In some implementations, individual recommended sets of automated actions may include the individual sets of repeated user actions. In some implementations, a recommendation may include a notification (e.g., pop-up message, email, and/or other notification) describing one or more of the individual sets of repeated user actions, the individual recommended sets of automated actions, the individual recommended trigger events, and/or other information. By way of non-limiting illustration, a set of repeated user actions for a given user may include generating a specific task, assigning the specific task to a specific person (or persons), adding a comment to the task, and/or other actions. The automation component 110 may determine that the set of repeated user actions for the given user is preceded by an other specific task being marked completed. The automation component 100 may be configured to generate a recommendation for automation information including a set of recommended automated actions including generating the specific task, assigning the specific task to the specific person (or persons), adding a comment to the task, and/or other actions. The automation component 110 may be configured such that the recommendation includes a recommended trigger event including the other specific task being “marked complete.”

In some implementations, automation component 110 may be configured to obtain and/or generate one or more automation templates. An automation template may specify a predetermined set of automated actions to carry out in the collaboration environment in response to occurrence of a predetermined trigger event. The one or more automation templates may be stored by electronic storage 128 and/or other storage device. In some implementations, an automaton template may represent sets of actions users may commonly carry out in response to an action and/or occurrence within the collaboration environment. In some implementations, automation templates may be created by system administrators, other users, based on repeated user actions, and/or created in other ways.

The conflict component 112 may be configured to analyze automation information to identify conflicts within the sets of automated actions and/or the trigger events. In some implementations, analyzing automation information may include simulating execution of the automation information in a testing environment to determine a potential outcome of the automation information. In some implementations, conflicts may include one or more of repeating and/or ongoing automated actions (e.g., where a set of automated actions may not have a finite end), an instance when an individual automated action comprises an individual trigger event (e.g., resulting in a looping of trigger-action-trigger-action, etc.), and/or other conflicts.

In some implementations, analyzing automation information may further include only allowing the execution of automated actions after a triggering event if the state specified in the actions are not already true. If they are already true, conflict component 112 may recognize this as a conflict and not execute the action(s) again.

In some implementations, configuring automation records, a user may use a user interface to construct and manipulate a representation of an automation record, rather than editing information within the automation record itself. This may allow conflict component 112 to prevent conflicts in the execution of the automation records being edited in the “live” versions of the automated records. Further, conflict component 112 may validate the representations and prevent configuration errors before saving them to the system 100.

In some implementations, conflict component 112 may be configured to analyze automation information as a user is specifying the automation information within a user interface (see, e.g., user interface component 114) and/or after the automation information has been specified and saved. The user interface may be configured to present errors at a number of possible failure points as the user is interacting with the user interface in real-time and/or near-real time. The possible failure points may include one or more of configuration failures, run time failures, cadence failures, container failures, editing failures, and/or other information.

The configuration failures may be related to if a user constructs a representation of an automation record that contains some sort of conflict and/or is invalid, conflict component 112 may validate that representation before saving or executing it, and notify the user contextually about the fixes that should be made in order to save and enable the automation record.

The run time failures may be related to determining that an automation record may be misconfigured when it attempts to execute the record, the conflict component 112 may send notifications (e.g., email, on-screen notifications, and/or other notification) containing information about the configuration error, and/or how to resolve it. A similar notification may also be sent by conflict component 112 if the execution fails due to some sort of system issue. In this case, the user may be notified that they do not need to take any action to resolve this failure.

The cadence failures may be related to when a trigger event may be misconfigured, the associated set of automated actions would never be executed because the trigger event may never be activated. To prevent this silent failure, the conflict component 112 may be configured to run checks on a regular cadence of the automation records within the system. This cadence check may iterate through the triggers and/or actions on individual automation records, and notify an appropriate user.

The container failures may be related to when a user visits a container object (e.g., project, portfolio, etc.), the conflict component 112 may present the user with pertinent status information about automation records associated with the container object, allowing them to fix any problems that may have arisen even without having seen any of the relevant notifications in other surface areas.

The editing failures may be related to editing an automation record with invalid components. A user may be directed through the user interface towards the specific components and/or associated inputs that may be causing an automation record to be invalid. This guided process may allow users to easily address and fix those issues so an automation record may resume operation.

The conflict component 112 may be configured to generate conflict reports based on the analysis. In some implementations, a conflict report may include a description of one or more conflicts and/or an indication of nonexistence of conflicts. In some implementations, a conflict report may provide an indication of elements of an automated action and/or trigger event which may comprise a source of conflict.

In some implementations, conflict component 112 may be configured to rate limit automated actions of one or more automation records. Rate limiting may include canceling and/or throttling execution of one or more automated actions based on one or more conditions. By way of non-limiting illustration, if one or more automated actions are triggered to execute more than X times in Y seconds, conflict component 112 may be configured to cancel one or more executions in that Y-second window. The values of X and/or Y may be user specified and/or specified by the system 100. In some implementations, if one or more automated actions at a project level are executed more than A times in B seconds, conflict component 112 may be configured to cancel one or more executions in that B-second window. The values of A and/or B may be user specified and/or specified by the system 100.

User interface component 114 may be configured to effectuate presentation of individual user interfaces on individual client computing platforms of one or more client computing platforms 104. For example, the individual client computing platforms may access a user interface over network 116. A given user interface may be configured to facilitate user specification of sets of automated actions and/or trigger events. In some implementations, user interface component 114 may be configured to prevent presentation of individual user interfaces configured to facilitate user specification (and/or modification) of sets of automated actions and/or trigger events by users who may not be authorized within system 100.

The user interface component 114 may be configured to effectuate presentation of a user interface through which users may specify and/or select one or more of one or more automated actions, one or more trigger events, one or more automation templates, and/or other information. In some implementations, a user interface may display one or more conflict reports. In some implementations, users may provide entry and/or selection of a period of time or times when an automaton record may be active (e.g., configured to be executed) and/or paused (e.g., configured to not be executed). By way of non-limiting illustration, a user interface element may comprise an “active/paused” toggle button.

The user interface may include one or more user interface portions. By way of non-limiting illustration, a user interface may include one or more input portions and/or other components. Individual portions may include one or more user interface elements configured to facilitate user interaction with the user interface. By way of non-limiting illustration, user interface elements may include one or more of text input fields, drop down menus, check boxes, display windows, virtual buttons, and/or other elements configured to facilitate user interaction.

An input portion of a user interface may be configured to obtain user input comprising one or more of user entry and/or selection of environment parameters to carry out actions on, entry and/or selection of values to apply to the entered and/or selected environment parameters, entry and/or selection of environment parameters associated with trigger events, entry and/or selection of values of environment parameters associated with trigger events, user entry and/or selection of one or more automation templates, and/or other information.

FIG. 3 illustrates an exemplary user interface 300, in accordance with one or more implementations. The user interface 300 may be configured to obtain user entry and/or selection of automation information and/or other information. The user entry and/or selection may be in the form of specification of automated actions, trigger events, and/or other information. Automated actions may be specified based on entry and/or selection of environment parameters to carry out actions on, entry and/or selection of values to apply to the entered and/or selected environment parameters, and/or other information. Trigger events may be specified based on one or more of entry and/or selection of environment parameters associated with trigger events, entry and/or selection of values of environment parameters associated with trigger events, and/or other information.

The user interface 300 may include a trigger input portion 304 to obtain entry and/or selection of a trigger event. The trigger input portion 304 may include a user interface element 308 configured to obtain information identifying a unit of work associated with the trigger event, a user interface element 310 configured to obtain entry and/or selection of an environment parameter associated with the trigger event, and a user interface element 312 configured to obtain entry and/or selection of a value for the environment parameter associated with the trigger event. For illustrative purposes, the trigger event in FIG. 3 may refer to the status of the task named “Task1” being “marked complete.”

The user interface 300 may include an automated action input portion 314 to obtain entry and/or selection of a set of automated actions. The automated action input portion 314 may include a user interface element 316 configured to obtain entry and/or selection of a first environment parameter associated with a first automated action and a user interface element 320 configured to obtain entry and/or selection of a first value for the first environment parameter. For illustrative purposes, the first environment parameter may include a work unit parameter for creating a unit of work and the first value may include a name value of “Task2.” Accordingly, the first automated action may refer to creating a unit of work with the name “Task2.”

The automated action input portion 314 may include a user interface element 322 configured to obtain entry and/or selection of a second environment parameter associated with a second automated action and a user interface element 324 configured to obtain entry and/or selection of a second value for the second environment parameter. For illustrative purposes, the second environment parameter may include a work assignment parameter and the second value may include a user's name. Accordingly, the second automated action may refer to assigning Task2 to “John Doe.”

The automated action input portion 314 may include a user interface element 326 configured to obtain entry and/or selection of a third environment parameter associated with a third action and a user interface element 328 configured to obtain entry and/or selection of a third value for the third environment parameter. For illustrative purposes, the third environment parameter may include a work unit parameter associated with the content of comments and the third value may include a specific comment, e.g., “You can do it!”. Accordingly, the third action may include adding a comment to the Task2 comments of “You can do it!”

It is noted that FIG. 3 is for illustrative purposes only and is not to be considered limiting. Instead, it is to be understood that the user interface 300 may be configured in other ways and/or including other elements in accordance with one or more implementations of the system 100 presented herein.

FIG. 4 illustrates a user interface 400, in accordance with one or more implementations. The user interface 400 may include one or more user interface elements configured to facilitate user interaction with the user interface 400. The user interaction may include input to select one or more automation templates. By way of non-limiting illustration, the user interface 400 may include a first user interface element 402, a second user interface element 406, and/or other user interface elements. The first user interface element 402 may be selected to effectuate a first template 404. The second user interface element 406 may be selected to effectuate a second template 408.

It is noted that FIG. 4 is for illustrative purposes only and is not to be considered limiting. Instead, it is to be understood that the user interface 400 may be configured in other ways and/or including other elements in accordance with one or more implementations of the system 100 presented herein.

In FIG. 1, in some implementations, server(s) 102, client computing platform(s) 104, and/or external resources 126 may be operatively linked via one or more electronic communication links. For example, such electronic communication links may be established, at least in part, via a network 116 such as the Internet and/or other networks. It will be appreciated that this is not intended to be limiting, and that the scope of this disclosure includes implementations in which server(s) 102, client computing platform(s) 104, and/or external resources 126 may be operatively linked via some other communication media.

A given client computing platform may include one or more processors configured to execute computer program components. The computer program components may be configured to enable an expert or user associated with the given client computing platform to interface with system 100 and/or external resources 126, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 126 may include sources of information outside of system 100, external entities participating with system 100, and/or other resources. In some implementations, some or all of the functionality attributed herein to external resources 126 may be provided by resources included in system 100.

Server(s) 102 may include electronic storage 128, one or more processors 130, and/or other components. Server(s) 102 may include communication lines, or ports to enable the exchange of information with a network 116 and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connected to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, 114, and/or other components. Processor(s) 130 may be configured to execute components 108, 110, 112, and/or 114, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, and/or 114 are illustrated in FIG. 1 as being implemented within a single processing unit, in implementations in which processor(s) 130 includes multiple processing units, one or more of components 108, 110, 112, and/or 114 may be implemented remotely from the other components. The description of the functionality provided by the different components 108, 110, 112, and/or 114 described below is for illustrative purposes, and is not intended to be limiting, as any of components 108, 110, 112, and/or 114 may provide more or less functionality than is described. For example, one or more of components 108, 110, 112, and/or 114 may be eliminated, and some or all of its functionality may be provided by other ones of components 108, 110, 112, and/or 114. As another example, processor(s) 130 may be configured to execute one or more additional components that may perform some or all of the functionality attributed below to one of components 108, 110, 112, and/or 114.

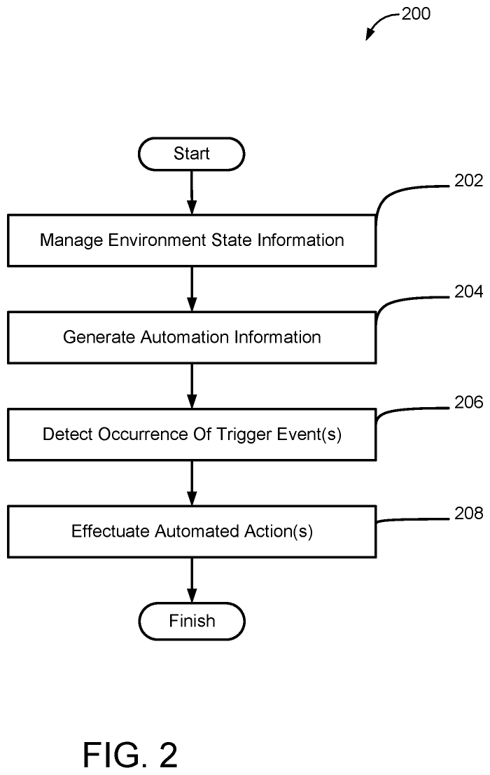

FIG. 2 illustrates a method 200 to effectuate sets of automated actions within a collaboration environment based on trigger events, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may manage environment state information maintaining a collaboration environment. The collaboration environment may be configured to facilitate interaction by users with the collaboration environment. The environment state information may specify values of environment parameters and/or other information. The environment parameters may include one or more of user parameters, work unit parameters, and/or other parameters. The values of the user parameters may describe one or more of the users, user actions of the users within the collaboration environment, user settings of the users, and/or other information about the users. The values of work unit parameters may describe units of work managed, created, and/or assigned within the collaboration environment, and/or other information about units of work. Operation 202 may be performed by one or more hardware processors configured by machine-readable instructions including a component that is the same as or similar to environment state component 108, in accordance with one or more implementations.

An operation 204 may generate automation information and/or other information. The automation information may be generated based on user entry and/or selection of the automation information into a user interface. The automation information may specify sets of automated actions to carry out in the collaboration environment in response to occurrence of trigger events. The user entry and/or selection of the automation information may include entry and/or selection of one or more of individual automated actions in individual sets of automated actions, individual trigger events, and/or other information. By way of non-limiting illustration, the automation information may specify a first set of automated actions to carry out in response to a first trigger event. The first set of automated actions and/or the first trigger event may be generated based on input by a first user into a user interface. Operation 204 may be performed by one or more hardware processors configured by machine-readable instructions including a component that is the same as or similar to automation component 110, in accordance with one or more implementations.

An operation 206 may detect occurrence of the trigger events. The occurrence of the trigger events may be based on changes in the values of the environment parameters and/or other events occurring within the collaboration environment. By way of non-limiting illustration, an occurrence of the first trigger event may be detected based on a first change in a first value of a first environment parameter to a second value. In some implementations, the first trigger event may be associated with the first change (e.g., a state change of the first environment parameter). In some implementations, the first trigger event may be associated with the second value (e.g., a data change of the first environment parameter). Operation 206 may be performed by one or more hardware processors configured by machine-readable instructions including a component that is the same as or similar to automation component 110, in accordance with one or more implementations.

An operation 208 may effectuate individual sets of automated actions within the collaboration environment. The effectuation of the individual sets of automated actions may be responsive to the detection of the occurrence of individual trigger events. By way of non-limiting illustration, responsive to the detection of the first trigger event, the first set of automated actions may be effectuated within the collaboration environment. Operation 208 may be performed by one or more hardware processors configured by machine-readable instructions including a component that is the same as or similar to automation component 110, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured to effectuate sets of automated actions within a virtual collaboration environment based on automatic detection of trigger events, the system comprising:
non-transitory electronic storage storing environment state information maintaining a virtual collaboration environment, the virtual collaboration environment being configured to facilitate interactions by users with the virtual collaboration environment, the users interacting with the virtual collaboration environment by accessing the virtual collaboration environment via remotely located client computing platforms over one or more Internet connections, the environment state information including work unit records, the work unit records including work unit information describing units of work managed by the users, created by the users, and assigned within the virtual collaboration environment to the users who are expected to accomplish one or more actions to complete the units of work; and
one or more physical processors are configured by machine-readable instructions to:
establish the one or more Internet connections between a server hosting the virtual collaboration environment and the remotely located client computing platforms;
effectuate communication of interface information from the server to the remotely located client computing platforms over the one or more Internet connections, wherein reception of the interface information by the remotely located client computing platforms causes the remotely located client computing platforms to present instances of a user interface of the virtual collaboration environment through which the users interact with the virtual collaboration environment;
obtain, at the server, user input information conveying user input of automation information into the instances of the user interface presented at the remotely located client computing platforms, the automation information specifying sets of automated actions to carry out in the virtual collaboration environment in response to occurrence of trigger events, such that the user input information conveys first user input of first automation information into a first instance of the user interface presented at a first remotely located client computing platform, wherein the first automation information specifies a first set of automated actions to carry out in response to a first trigger event;
generate, at the server, automation records, the automation records including the automation information obtained from the user input;
effectuate storage of the automation records in the non-transitory electronic storage;
continuously monitor, at the server, the environment state information for changes in the work unit information of the work unit records resulting from the interactions by the users with the virtual collaboration environment via the instances of the user interface presented at the remotely located client computing platforms;
detect, at the server, occurrence of the trigger events based on monitoring the environment state information, such that an occurrence of the first trigger event is detected based on a first change in first work unit information of a first work unit record to second work unit information; and
responsive to the detection of the occurrence of the trigger events, effectuate, at the server, the sets of automated actions within the virtual collaboration environment, such that responsive to the detection of the first trigger event, effectuate the first set of automated actions within the virtual collaboration environment.

2. The system of claim 1, wherein individual trigger events are associated with individual occurrences of change of the work unit information of individual work unit records, such that the first trigger event is associated with the first change.

3. The system of claim 1, wherein individual trigger events are associated with substance of change to the work unit information of individual work unit records, such that the first trigger event is associated with the first work unit information becoming the second work unit information.

4. The system of claim 1, wherein the first set of automated actions includes creating a second work unit record.

5. The system of claim 4, wherein the second work unit record is created by generating an instance of a record within the non-transitory electronic storage, generating second work unit information, and storing the second work unit information in the instance of the record.

6. The system of claim 4, wherein the first set of automated actions further includes effectuating change in, and/or specification of, the work unit information of a third work unit record.

7. The system of claim 6, wherein one or more automation actions of the first set of automation actions are carried out after a specified time frame following the detection of the first trigger event.

8. The system of claim 1, wherein the one or more physical processors are further configured by the machine-readable instructions to:
determine, at the server and based on the monitoring the environment state information, individual sets of repeated user actions by individual ones of the users;
generate, at the server, recommendations for new ones of the automation records based on the individual sets of repeated user actions, the recommendations describing individual recommended sets of automated actions to carry out in response to individual recommended trigger events which correspond to the individual sets of repeated user actions; and
effectuate communication of information defining the recommendations from the server to the remotely located client computing platforms via the one or more Internet connections to cause the remotely located client computing platforms to present the recommendations in the user interface.

9. The system of claim 1, wherein the interactions by the users with the virtual collaboration environment resulting in the changes in the work unit information of the work unit records include one or more of marking individual work unit records complete, reassigning the individual work unit records, changing dates associated with the individual work unit records, or creating new ones of the work unit records.

10. The system of claim 9, wherein the first change is a reassignment of the first work unit record from a first user to a second user.

11. A computer-implemented method to effectuate sets of automated actions within a virtual collaboration environment based on automatic detection of trigger events, the method being implemented in a computer system comprising non-transitory electronic storage storing machine-readable instructions, one or more physical processors configured to execute the machine-readable instructions, and a server hosting the virtual collaboration environment, such that execution of the machine-readable instructions by the one or more physical processors causes the one or more physical processors to perform the method, the method comprising:
electronically storing, within the non-transitory electronic storage, environment state information maintaining a virtual collaboration environment, the virtual collaboration environment being configured to facilitate interactions by users with the virtual collaboration environment, the users interacting with the virtual collaboration environment by accessing the virtual collaboration environment via remotely located client computing platforms over one or more Internet connections, the environment state information including work unit records, the work unit records including work unit information describing units of work managed by the users, created by the users, and assigned within the virtual collaboration environment to the users who are expected to accomplish one or more actions to complete the units of work; and
establishing the one or more Internet connections between the server hosting the virtual collaboration environment and the remotely located client computing platforms;
effectuating communication of interface information from the server to the remotely located client computing platforms over the one or more Internet connections, wherein reception of the interface information by the remotely located client computing platforms causes the remotely located client computing platforms to present instances of a user interface of the virtual collaboration environment through which the users interact with the virtual collaboration environment;
obtaining, at the server, user input information conveying user input of automation information into the instances of the user interface presented at the remotely located client computing platforms, the automation information specifying sets of automated actions to carry out in the virtual collaboration environment in response to occurrence of trigger events, wherein the user input information conveys first user input of first automation information into a first instance of the user interface presented at a first remotely located client computing platform, and wherein the first automation information specifies a first set of automated actions to carry out in response to a first trigger event;
generating, at the server, automation records, the automation records including the automation information obtained from the user input;
electronically storing the automation records in the non-transitory electronic storage;
continuously monitoring, at the server, the environment state information for changes in the work unit information of the work unit records resulting from the interactions by the users with the virtual collaboration environment via the instances of the user interface presented at the remotely located client computing platforms;
detecting, at the server, occurrence of the trigger events based on monitoring the environment state information, including detecting an occurrence of the first trigger event based on a first change in first work unit information of a first work unit record to second work unit information; and
responsive to the detection of the occurrence of the trigger events, effectuating, at the server, the sets of automated actions within the virtual collaboration environment, including responsive to the detection of the first trigger event, effectuating the first set of automated actions within the virtual collaboration environment.

12. The method of claim 11, wherein individual trigger events are associated with individual occurrences of change of the work unit information of individual work unit records, such that the first trigger event is associated with the first change.

13. The method of claim 11, wherein individual trigger events are associated with substance of change to the work unit information of individual work unit records, such that the first trigger event is associated with the first work unit information becoming the second work unit information.

14. The method of claim 11, wherein the first set of automated actions includes creating a second work unit record.

15. The method of claim 14, wherein the second work unit record is created by generating an instance of a record within the non-transitory electronic storage, generating second work unit information, and storing the second work unit information in the instance of the record.

16. The method of claim 14, wherein the first set of automated actions further includes effectuating change in, and/or specification of, the work unit information of a third work unit record.

17. The method of claim 16, wherein one or more automation actions of the first set of automation actions are carried out after a specified time frame following the detection of the first trigger event.

18. The method of claim 11, further comprising:
determining, at the server and based on the monitoring the environment state information, individual sets of repeated user actions by individual ones of the users;
generating, at the server, recommendations for new ones of the automation records based on the individual sets of repeated user actions, the recommendations describing individual recommended sets of automated actions to carry out in response to individual recommended trigger events which correspond to the individual sets of repeated user actions; and
effectuating communication of information defining the recommendations from the server to the remotely located client computing platforms via the one or more Internet connections to cause the remotely located client computing platforms to present the recommendations in the user interface.

19. The method of claim 11, wherein the interactions by the users with the virtual collaboration environment resulting in the changes in the work unit information of the work unit records include one or more of marking individual work unit records complete, reassigning the individual work unit records, changing dates associated with the individual work unit records, or creating new ones of the work unit records.

20. The method of claim 19, wherein the first change is a reassignment of the first work unit record from a first user to a second user.
